(19) United States
(12) Patent Application Publication
(10) Pub. No.: US 2002/0143787 A1
(43) Pub. Date: Oct. 3, 2002

(54) Fast classless inter-domain routing (CIDR) lookups

(76) Inventors: Simon Knee, Del Mar, CA (US); Ronald S. Perloff, Poway, CA (US)

Correspondence Address: Michael A. DeSanctis, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/823,616

(22) Filed: Mar. 31, 2001

(51) Int. Cl. G06F 7/00

(52) U.S. Cl. 707/102

(57) ABSTRACT

A method and apparatus for efficiently performing a longest match search are provided. According to one embodiment of the present invention, a longest match search of a routing table is initiated in response to receiving a search key (typically a destination IP address of a received packet). To avoid performing fruitless searches, a set of masks are determined that are known to have a potential for matching an entry in the routing table when applied to the search key. A routing table query is formed based upon the search key and the longest mask of the set of masks. Then, the routing table query is applied to the routing table. If subsequent iterations are required, the longest mask is removed from the set of masks and the next routing table query is formed based upon the search key and the longest mask of the updated set of masks.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### BACKGROUND OF THE INVENTION

1. Field of the Invention

The invention relates generally to the field of networking devices. More particularly, the invention relates to a method and apparatus for quickly and efficiently locating a longest matching prefix of a given address in an Internet Protocol (IP) routing table, a forwarding database, or the like.

2. Description of the Related Art

A network device's performance is based on how quickly it can forward a packet. Before a network device, such as a router or a switch, can forward a packet, it must identify the most appropriate entry in its routing table that corresponds to the destination address specified in the packet. As a result, address matching is a critical part of making a high-performance network device.

Historically, 32-bit Internet Protocol (IP) version 4 (IPV4) addresses were assigned to organizations in contiguous blocks of 16,777,216 hosts specified by the most significant 8 bits and known as Class A, blocks of 65,536 specified by the most significant 16 bits and known as Class B, and blocks of 256 specified by the most significant 24 bits and known as Class C. As networking became more widespread, it became clear to those in the technical community that this allocation scheme was very wasteful of a limited addressing space since even relatively small entities could easily have a need for more than 256 addresses and the next step up was 65,536 addresses. To alleviate the problem, the networking community has adopted the Classless Inter-Domain Routing (CIDR) scheme in which addresses are allocated in contiguous blocks of any size that can be described as two taken to an integer power. Routers, which forward packets from one device to another, can save space in their routing tables by maintaining forwarding instructions for the address blocks rather than individual addresses. However, some difficulty arises in that, depending on the router's position within the network, it might have to treat some addresses within a block differently than the others.

Specifically, if an IP destination address matches more than one entry in the routing table, the router should forward the packet according to the forwarding instructions associated with the entry having the most “specific” matching routing table entry, e.g., the “longest match” or the “best prefix match.” An IP address comprises a portion identifying a network prefix and a portion identifying a host number. An IP address with a longer network prefix describes a smaller set of destinations and is said to be more specific than an IP address with a shorter network prefix. Therefore, when forwarding traffic, a network device must choose the entry with the longest matching network prefix. The length of an entry's network prefix may be identified by a length attribute or by a “mask” associated with the entry.

Referring now to FIG. 1, a brute force approach for performing a longest match search is illustrated. In this example and in other parts of the application, an efficient 33-bit encoding is used to represent address groups having the form <hex_number>/<sig_bits>, where hex_number is an eight digit hexadecimal representation of the IP address or group of addresses and sig_bits is a number between 1 and 32 indicating how many of the most significant bits must match in order for a query to be considered a match. The 33-bit encoding is formed by concatenating the first sig_bits of the address, followed by a binary ‘1’, followed by (32-sig_bits) of binary zeroes.

Thus:

AB120000/16 is represented as 101010110001001010000 000000000000 and

AB120000/24 is represented as 1010101100010010 00000000100000000 and

AB120000/32 is represented as 101010110001001000000000000000001

At any rate, in a brute force approach, an original query to the database (routing table) for the 32-bit address 101 01011.00010010.0110100.01010110 (hex_number: AB123456) can be transformed into 32 separate 33-bit queries 101-132 starting with the original query to which a binary 1 is appended 101 (i.e., sig_bits=32), followed by a query in which the bottom bit of the original query is replaced by a 1 and a 0 is appended 102 (i.e., sig_bits=31), followed by a query in which the bottom two bits are replaced with binary 10 and a binary 0 is appended 103 (i.e., sig_bits=30) and so on. Thus, each successive query attempts to match one less bit than the query that preceded it. This approach attempts to find each of the queries 101-132 in this order in the database and stops when it finds a match. Since this approach is trying to find matches in decreasing order of the number of bits matched, it will find the longest match possible for the original query. In most current databases, however, the bulk of the addresses represented have masks (sig_bits) of 32, 24, or 16 bits. That is, the network prefix represented by the most significant bits that must match in order for a query to be considered a match is typically 32, 24, or 16 bits long. Consequently, this brute force approach wastes a lot of time looking for network prefix values that are not likely to produce a match. While there have been many improvements upon this brute force approach, the problem of performing fruitless searches remains.

### BRIEF DESCRIPTION OF THE SEVERAL VIEWS OF THE DRAWINGS

The present invention is illustrated by way of example, and not by way of limitation, in the figures of the accompanying drawings and in which like reference numerals refer to similar elements and in which:

FIG. 1 illustrates an exemplary query sequence according to a brute force longest match search approach.

FIG. 2 is a simplified block diagram of an exemplary packet forwarding device in which various embodiments of present invention may be implemented.

FIG. 3 conceptually illustrates a routing table that includes three network prefixes of varying lengths.

FIG. 4 is a flow diagram illustrating packet forwarding/routing processing according to one embodiment of the present invention.

FIG. 5 is a high-level flow diagram illustrating longest match search processing according to one embodiment of the present invention.

FIG. 6 conceptually illustrates a routing table and a corresponding set of encoded mask vectors according to one embodiment of the present invention.

FIG. 7 is a more detailed flow diagram illustrating longest match search processing according to one embodiment of the present invention.

FIG. 8 conceptually illustrates a hardware implementation of mask extraction according to one embodiment of the present invention.

FIGS. 9 and 10 illustrate the function of the hardware implementation of FIG. 8 and subsequent expansions according to one embodiment of the present invention.

### DETAILED DESCRIPTION OF THE INVENTION

A method and apparatus for efficiently performing a longest match search are described. Using the teachings of the present invention, a network device may more quickly forward packet data since the longest match search for the most appropriate entry in the routing table is accelerated. Broadly stated, embodiments of the present invention use advanced knowledge about the contents of the routing table to skip searches known ahead of time to be fruitless. According to one embodiment of the present invention, a table of encoded mask vectors is employed that precludes fruitless searches by identifying only those mask lengths that have the potential of matching an entry in the routing table for a particular group of original query values. As will be described further below, the table is indexed by some number of the most significant bits of the original query and contains a set of bit vectors representing all valid network prefix values for addresses whose most significant bits match that index. For example, if the first 16 bits of a query were used as the index into this table, then the table would contain 65,536 vectors. Further, if AB120000/24 and AB120034/32 were the only address groups represented that started with AB 12, then the encoded mask vector (e.g., MaskWord[31:0]) stored at index AB12 might be represented, according to one embodiment, as 32 bits with a 1 in bit positions eight and zero, thereby producing a 32-bit and a 24-bit mask during a mask expansion process and identifying the only queries that have a potential match in the routing table for an original query beginning with AB12

Advantageously, by employing the table of encoded mask vectors described above, a longest match for an address may be quickly and efficiently identified by querying the routing table with progressively less significant bits of the address while excluding those searches known to be fruitless by searching for only those address groups that have a potential match as indicated by the encoded mask vector corresponding to the address.

According to another embodiment, an efficient mechanism is provided for expanding the encoded mask vectors into the appropriate series of masks in an environment in which a ripple OR circuit would be hard or inefficient to build. Briefly, the first mask may be formed by ORing the 2's compliment of the encoded mask vector with the encoded mask vector itself. Subsequent masks may be formed by creating a new encoded mask vector by ANDing the original encoded mask vector with the current mask after it has been shifted left one position. At any rate, while a ripple OR circuit implementation would be an apparent approach if the designer had the luxury of implementing with ASICs, proposed herein is a fast, compact solution for target platforms other than ASICs, such as software running on a standard processor or an FPGA.

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various steps, which will be described below. The steps of the present invention may be performed by hardware components or may be embodied in machine-executable instructions, which may be used to cause a general-purpose or special-purpose processor programmed with the instructions to perform the steps. Alternatively, the steps may be performed by a combination of hardware and software.

The present invention may be provided as a computer program product that may include a machine-readable medium having stored thereon instructions, which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnetic or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Importantly, while embodiments of the present invention will be described with reference to Internet Protocol (IP) version 4 (IPv4) 32-bit addresses, the method and apparatus described herein are equally applicable to shorter or longer address lengths, such as the 128-bit address formats expected in the deployment of IP Next Generation (IPng or IPv6).

An Exemplary Network Device Architecture

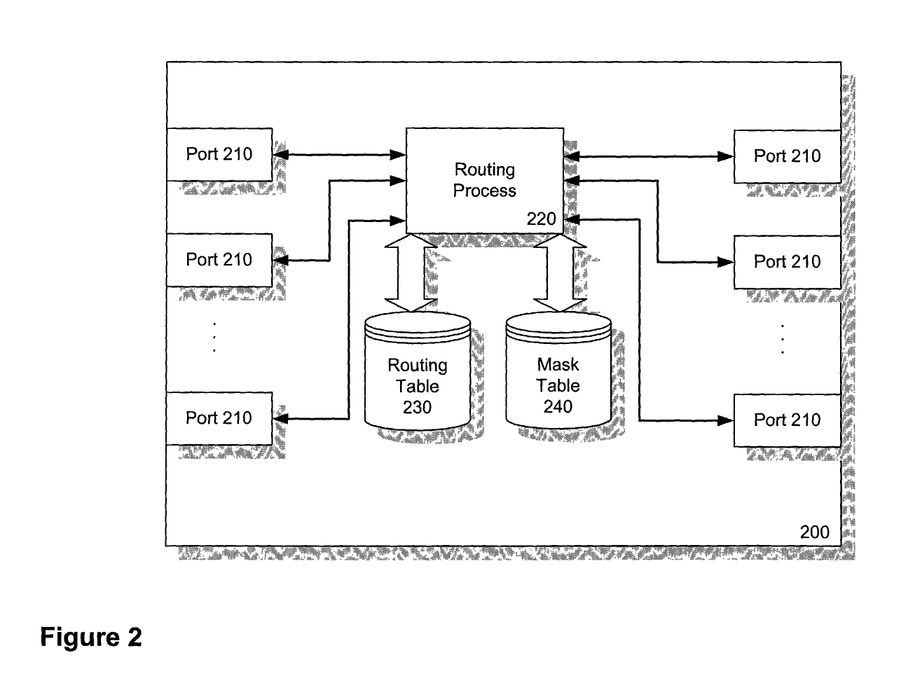

A high-level, simplified overview of the architecture of a network device, e.g., router 200, in which an embodiment of the present invention may be implemented is illustrated by FIG. 2. According to this example, router 200 includes a plurality of input/output (I/O) ports 210, a routing process 220, a routing table 230, and a mask table 240. The I/O ports 210 are coupled in communication with the routing process 220 which in turn interfaces with both the routing table 230 and the mask table 240.

The routing process 220 performs packet routing/forwarding using the longest best match, thus supporting Classless Inter-Domain Routing (CIDR) and Variable Length Subnet Masks (VLSM). Data, typically in the form of variable-length packets, enters the router 200 via one of the plurality of I/O ports 210 (the ingress port). The inbound packet data is provided by the ingress port to the routing process 220 which steers the data to the appropriate destination I/O port(s) 210 (the egress ports). According to one embodiment, the routing process 220 implements an improved longest match search which locates the longest match of a given address (search key) in the routing table 230 more quickly than traditional approaches. In this manner, packets are forwarded more quickly and the overall performance of the router 200 is enhanced. Details regarding the improved longest match search will be described further below.

Generally speaking, the routing table 230 includes information that indicates on which port (the egress port) a particular address is located. The routing table 230 typically includes entries having address data and a corresponding payload. The payload may be the forwarding instructions for the particular address or an indication (e.g., an index or a pointer) that can be used to find the forwarding instructions for the particular address. According to one embodiment, the routing table 230 is implemented in whole or part as a Content Addressable Memory (CAM), a random access memory (RAM), such as synchronous RAM (SRAM), or the like that may be implemented using hashing techniques. For example, a hash index generator (not shown), such as a cyclic redundancy checksum (CRC) generator may produce a hash index based on the destination IP address of the packet to be forwarded and the corresponding mask.

The mask table 240 contains information about the contents of the routing table 230, such as information regarding the mask lengths that have the potential of matching an entry in the routing table 230 for a particular set of query values. According to one embodiment of the present invention, the mask table 240 comprises encoded mask vectors that are added, deleted or modified as addresses are added to or deleted from the routing table 230. In this manner, during the longest match search, the routing process 220 may skip mask lengths that have no potential of matching an entry in the routing table 230.

Briefly, in operation, the routing process 220 determines appropriate masks to apply to a search key associated with a received packet with reference to the mask table 240 and then queries the routing table 230 to identify the appropriate forwarding instructions for the received packet. For example, the routing process 220 may retrieve an encoded mask vector corresponding to a destination network layer address contained in the received packet (e.g., a destination IP address) from the mask table 240 and then perform one or more address look-up requests using those of the masks indicated by the encoded mask vector to have a potential for matching an entry in the routing table 230.

Brief Overview of Longest Match Search Principles

It should be appreciated that address matching directly affects the performance of a network device, such as a bridge, a router, or a switch. As described above, before a network device can make a forwarding decision relating to a packet, it must locate the most appropriate entry in its routing table corresponding to a search key, typically a destination address, associated with or specified in the packet. Locating the appropriate routing table entry involves performing a longest match search.

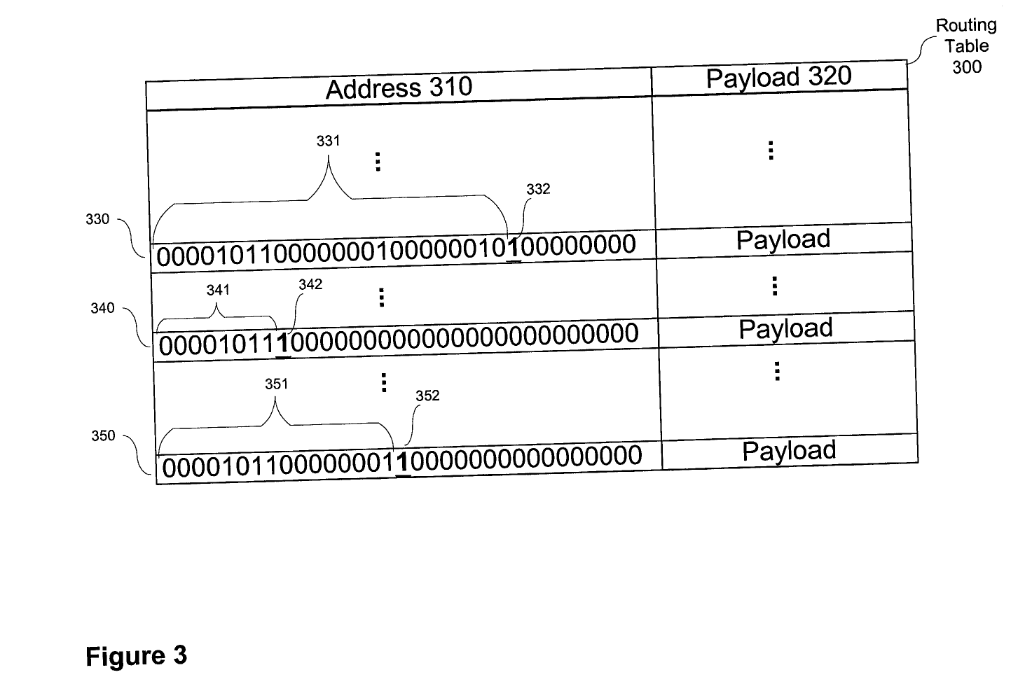

FIG. 3 conceptually illustrates a routing table 300 that includes three routing table entries 330, 340, and 350 having network prefixes 331, 341, and 351, respectively, of varying lengths. In this example, the routing table 300 includes an address field 310 and a payload field 320. The addresses for entries 330, 340 and 350 are represented in the 33-bit encoding described above. That is, address groups having the form <hex_number>/<sig_bits> are represented as 33-bit vectors rather than the traditional 32-bit address and 32-bit mask vector. The 33-bit encoding is formed by concatenating the first sig_bits of the address, followed by a binary ‘1’, followed by (32 sig_bits) of binary zeroes. Therefore, the first one bit encountered in a scan from LSB to MSB of the 33-bit address information is the mask length indicator. The mask length for an entry may be determined by subtracting the bit position of the mask length indicator from the bit position of the MSB of the address.

Therefore, in this example, network prefix 331, 0B.01.02.00, has a 24-bit mask as indicated by the position of the last binary ‘1’ 332 in the address field 310, network prefix 341, 0B.0.0.0, has an 8-bit mask due to the position of the last binary ‘1’ 342, and network prefix 351, 0B.01.0.0, has a 16-bit mask as indicated by the position of the last binary ‘1’ 352.

At any rate, using this simplified example, a longest match search will be illustrated for a destination address 0B.01.02.F0 (the search key). In Transmission Control Protocol/Internet Protocol (TCP/IP), there might be several entries of a routing table that match a particular address. In this example, network prefix 331 of route (entry) 330, network prefix 341 of route (entry) 340, and network prefix 351 of route (entry) 350 all match 0B.01.02.F0. However, to assure proper delivery of the packet, a network device must use the most specific matching entry, i.e., the entry having the longest mask. Importantly, to be considered a matching entry, the address associated with the entry must match a portion of the search key identified by its mask and the entry's mask length must be less than or equal to the search key's mask length.

Assuming entries 330, 340, and 350 were the only entries beginning with 0B, using the match criteria discussed above and using the longest match technique that will be described further below, a search of the routing table 300 would be limited to the following three search keys: (1) 0B.01.02.00/24, (2) 0B.01.00.00/16, and (3) 0B.00.00.00/08. However, upon locating a match (i.e., entry 330) during the first search, no further searches would be required.

Packet Forwarding/Routing Processing Overview

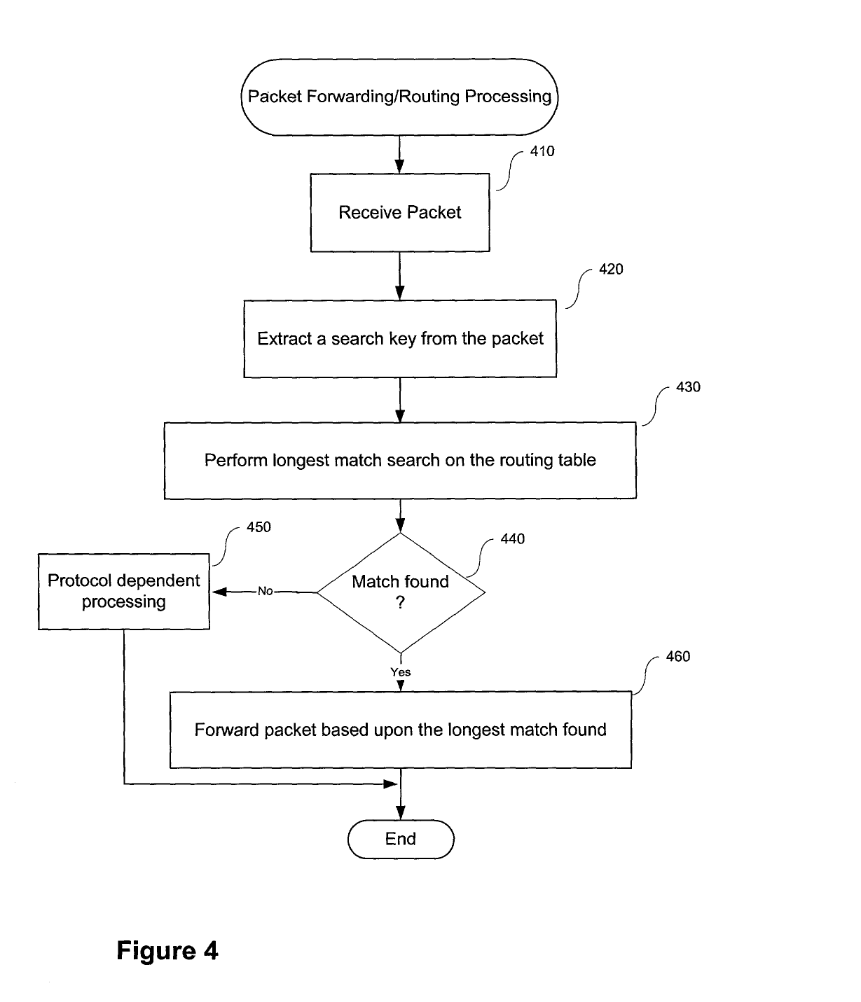

FIG. 4 is a flow diagram illustrating packet forwarding/routing processing according to one embodiment of the present invention. In one embodiment, the processing blocks described below may be performed under the control of a programmed processor, such as processor 402. However, in alternative embodiments, the processing blocks may be fully or partially implemented by any programmable or hard-coded logic, such as Field Programmable Gate Arrays (FPGAs), TTL logic, or Application Specific Integrated Circuits (ASICs), for example.

At processing block 410, a packet is received at the ingress I/O interface. A search key is extracted from the packet at processing block 420. For an Internet Protocol (IP) packet, the search key typically comprises the source or destination IP address embedded in the packet's header. At processing block 430, a longest match search is performed to locate the most appropriate routing table entry for the search key. A determination is made at decision block 440 if a match was found. If a match was not found for the search key, then various protocol dependent processing may take place at processing block 450 depending upon the implementation. For example, the packet may be forwarded to the CPU for resolution of a default route. Assuming a match was found, at processing block 460, the packet may then be forwarded to the egress I/O interface associated with the matching entry.

Longest Match Search Processing

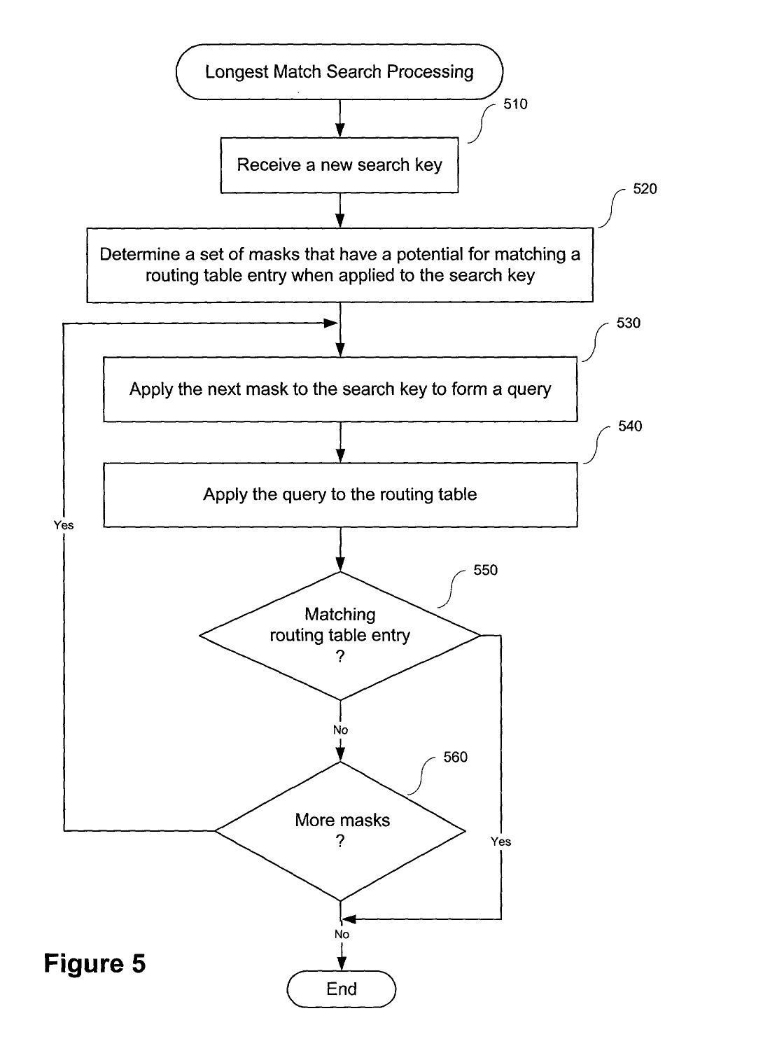

Having described an exemplary usage model and context, longest match search processing, according to one embodiment of the present invention, will now be described at a high-level with reference to FIG. 5. The steps may be performed under the control of a programmed processor, or the logic may be implemented and distributed among hardware, firmware, software, or a combination thereof within the I/O interfaces 210 and/or the routing process 220, for example.

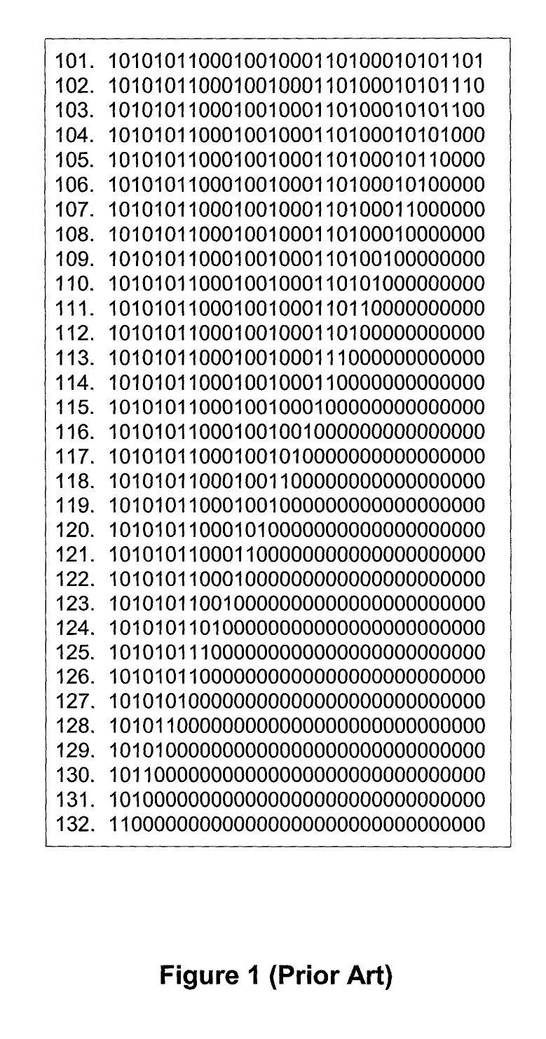

In general, an iterative process is used to find a matching routing table entry. During the first and each successive iteration, a routing table query is formed based upon the search key and the current mask. Assuming bit-wise decimation of the mask, a worst case routing table search involves attempting to locate a match for a search key that matches none of the routing table entries. In this case, as illustrated with respect to FIG. 1, N routing table queries are performed where N is the length of the search key. According to embodiments of the present invention, rather than being a function of the length of the search key, the worst case number of routing table queries required is a function of the number of unique mask lengths represented by entries existing in the routing table that are known to be potential matches, thereby reducing the average number of iterations. For example, iterations involving search key masks greater than M bits can be avoided if the only potential matches in the routing table are those having mask lengths of M or less.

At processing block 510, a new search key is received. As indicated above, typically, the new search key comprises a source or destination IP address extracted from the packet to be forwarded.

At processing block 520, a set of masks is determined. Importantly, rather than simple-mindedly using a mask reduced by one bit for the generation of each successive routing table query as illustrated above with respect to a brute force routing table search, based upon knowledge of the content of the routing table 230, the set of masks generated in block 520 excludes those masks that would result in a fruitless routing table search. For example, if the only entries with the potential to match the search key have mask lengths of 16 and 8-bits, then the set of masks can be limited to two masks, one of length 16 and the other of length 8. In this manner, the improved longest match search described herein is more efficient in terms of query generation by avoiding unproductive routing table queries.

At processing block 530, the next mask from the set of masks determined in processing block 520 is applied to the search key to form a routing table query. Then, at processing block 540, the query is applied to the routing table 230.

At decision block 550, a determination is made as to whether or not a match has been found. Recall, a match requires the routing table entry's mask length to be less than or equal to the mask associated with the search key and the masked search key must be equivalent to the address information associated with the entry. Therefore, match determination includes determining the entry's mask length and if the mask length is less than or equal to the search key's mask, then comparing the masked search key to the entry's address information. If the match determination fails, then processing continues with processing block 560. However, if a matching entry is found, the longest match search is complete.

At decision block 560, a determination is made whether additional masks remain to be processed. If so, processing branches back to processing block 530; otherwise processing is complete. Processing blocks 530 through 560 are repeated for each mask determined by processing block 520 until either a matching entry is located or the set of masks is exhausted.

Routing Table and Mask Table Maintenance

According to embodiments of the present invention, more intelligent routing table query generation reduces the number of iterations involved in a typical routing table search and thereby reduces the overhead involved in forwarding/routing a typical packet from the ingress port to the egress port. The more intelligent routing table query generation is accomplished based upon summary information regarding the content of the routing table 230 that is maintained in the mask table 240.

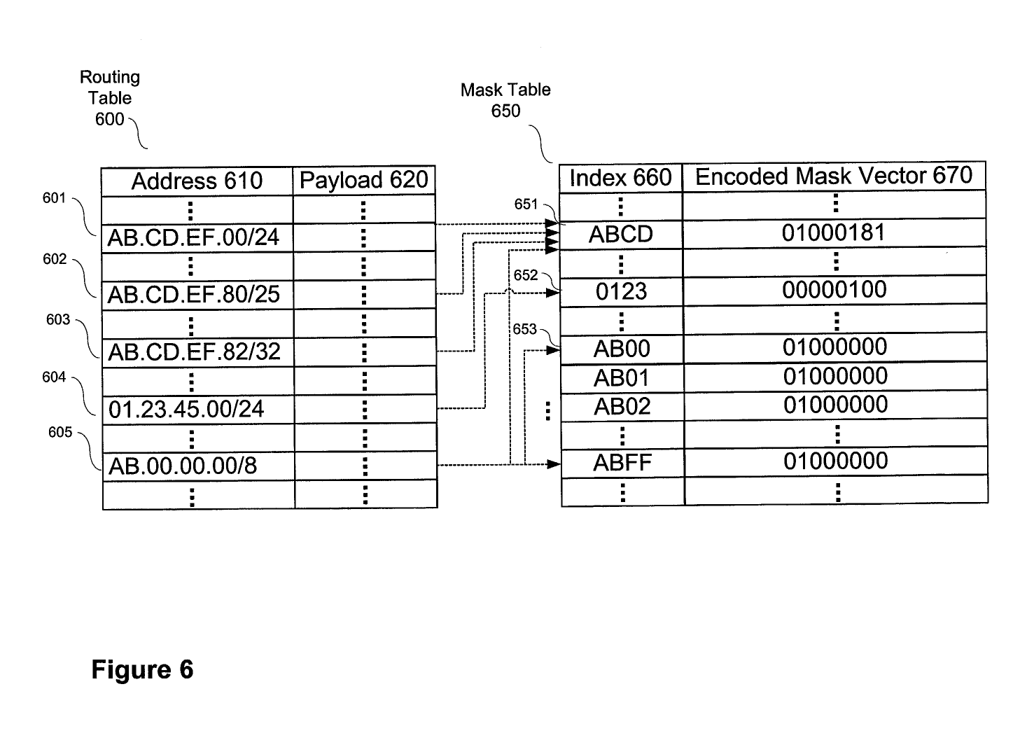

FIG. 6 conceptually illustrates a routing table 600 and a corresponding mask table 650 according to one embodiment of the present invention. In this example, the routing table 600 includes entries 601-605 each having an address field 610 and a payload field 620. On a periodic basis or in real-time as routing table entries are created, modified, or deleted, the mask table 650 is updated to reflect the contents of the routing table 600.

The mask table 650 includes entries 651-653 each having an encoded mask vector 670 and indexed by index 660. hi the embodiment illustrated, the encoded mask vectors are 32-bit vectors (MaskWord[31:0]) and the indices are 16-bits both of which are expressed in hexadecimal format. In alternative embodiments, the encoded mask vectors 670 may be longer or shorter to accommodate the search key length and the index 660 may be tuned to reflect the implementer's desired mask table size/performance tradeoff.

At any rate, each ‘1’ bit in a particular encoded mask vector represents at least one entry in the routing table 600 that matches the index of the entry and has a mask of length 32 minus the bit position of the ‘1’ bit. For example, the encoded mask vector, 01000181, of entry 651 in the mask table 650 provides the following information about the routing table 600: (1) there are at least four routing table entries that begin with ABCD having different mask lengths and (2) the mask lengths are 8-bits (32-24 (the bit position of the most significant ‘1’ bit)), 24-bits (32-8 (the bit position of the next most significant ‘1’ bit)), 25-bits (indicated by the third most significant ‘1’ bit), and 32-bits (indicated by the least significant ‘1’ bit). In alternative embodiments, ‘0’ bits may be used in place of ‘1’ bits to indicate mask lengths and other mask length encoding schemes may be employed, for example the bit position of the mask length indicators (e.g., ‘0’ or ‘1’ bits) may directly indicate the mask length rather than indirectly as described above.

The routing table 600 includes entries 601-605 each having an address field 610 and a payload field 620. In this example as indicated by the dotted lines, the encoded mask vector 670 of mask table entry 651 is a product of combining (e.g., ORing) the encoded mask length indications of routing table entries 601, 602, 603, and 605. Similarly, the encoded mask vector 670 of mask table entry 652 is a result of the presence of routing table entry 604. Finally, the encoded mask vectors 670 of the 255 mask table entries starting at entry 653 are a result of routing table entry 605.

Longest Match Search Processing

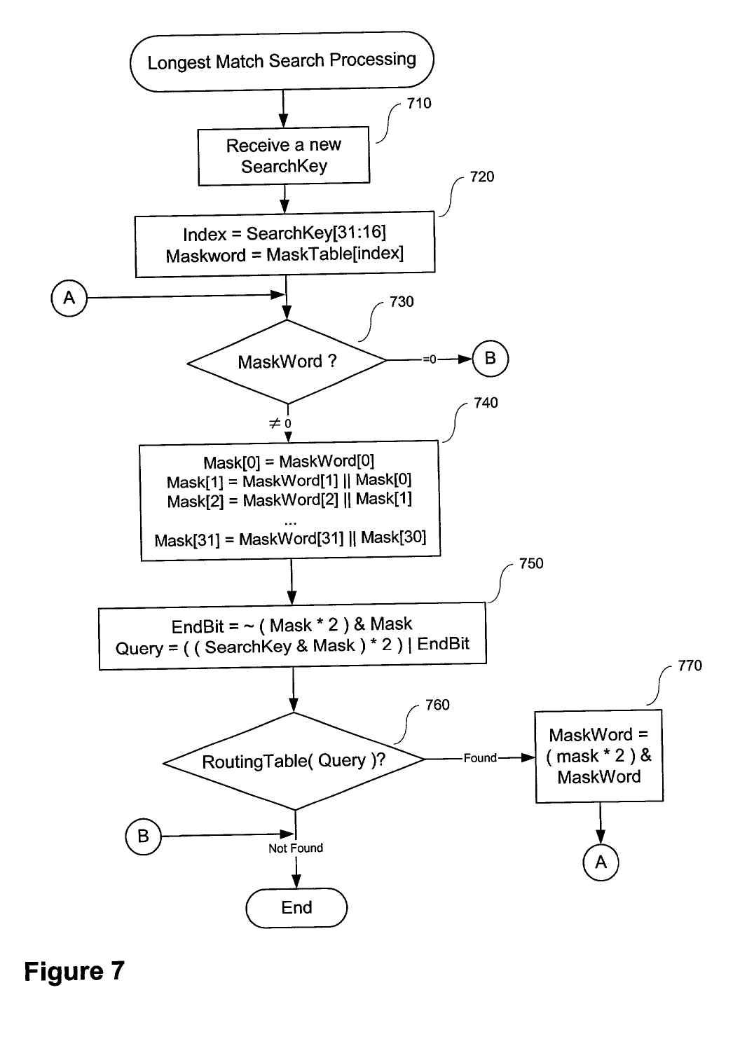

FIG. 7 is a more detailed flow diagram illustrating longest match search processing according to one embodiment of the present invention. Briefly, the longest match search process queries the routing table 230 once per iteration looking for an entry that matches a search key. The query is formed by applying a current mask to the search key. If a match is not found in the routing table 230, the mask is modified (shortened) and applied to the search key to form a query for the next iteration until either a matching entry is found or all potential masks have been used.

At processing block 710, a new search key (e.g., SearchKey[31:0]) is received. At processing block 720 the index into the mask table 240 is determined and the encoded mask vector (e.g., MaskWord[31:0]) corresponding to the search key is retrieved from the mask table 240. While in this example the most significant 16 bits of the search key are used as the index to the mask table 240, in alternative embodiments, other portions of the search key may be employed and more or less bits may be used. Also, more complex hashing techniques, such as CRC, may be used to generate the index.

At decision block 730, a determination is made whether any further masks are to be attempted. If MaskWord is greater than zero, then at least one more mask remains to be tried and processing continues with processing block 740. However, if MaskWord is equal to zero, then there are no further entries in the routing table 230 that can match the query at any length and longest match search processing is terminated. According to an alternative embodiment, the test for a zero MaskWord is eliminated and instead a special routing table entry is created to match a query of all zeroes and then terminate the search.

At processing block 740, one possible method for forming a 32-bit mask from the MaskWord is shown. This method uses a ripple technique, which can be quite compact in ASIC implementations. If the performance of such a ripple circuit is insufficient to meet the needs of the design, periodic lookaheads can ameliorate the problem. For example, the logic can be segmented into groups of X bits in which each bit of the mask other than the bottom bit is formed by the OR of the corresponding bit of the MaskWord with the next lower bit of the mask itself. The bottom bit of the bottom group is just the bottom bit of the MaskWord. The bottom bit of the next group is formed by the OR of the corresponding bit of the MaskWord with the lookahead from the bottom group that is the OR of the bottom X bits of the MaskWord. The bottom bit of the third group is the OR of the corresponding bit of the MaskWord with the second lookahead which is formed by the OR of all the bits of the second group of X bits in the MaskWord and the first lookahead, etc. Another mask extraction technique is described further below which works very well when the mask is formed in a standard processor or in an FPGA where a ripple OR circuit would be hard or inefficient to build.

At processing block 750, the bottom bit (e.g., EndBit) of the mask is isolated by the AND of the mask with the inversion of the mask that has been left-shifted one position. Then, the query is formed by the OR of the masked search key left-shifted one position with the EndBit. In an alternative embodiment, after the initial query has been formed, subsequent queries are formed using the most recent query shifted right one position rather than using the search key.

At decision block 760, the result of the routing table query is tested. The CAM query operation, if successful, yields a result and a “found” indication, ending the longest match search process. If the CAM indicates “not found”, the process continues by creating a new MaskWord at processing block 770.

At processing block 770, the MaskWord for the next iteration is formed by ANDing the current mask left shifted one position, with the current MaskWord and the processing returns to the test for a zero MaskWord. In an alternative implementation, the new MaskWord may be formed by ANDing the left-shifted mask with the original MaskWord.

Mask Extraction

Sometimes it is convenient or important to associate a number of masks with a single datum. If those masks can be guaranteed to be a series of contiguous ones followed by a series of contiguous zeroes, i.e., of the form 1111 . . . 10000 . . . 0, then the set of masks can be stored in a compact vector as indicated above in which each mask is represented by a one in the position of the lowest order one in the mask. For example, the masks 1111100000 and 11111100 can be represented by the MaskWord 00010100. One way of implementing lookups for the Classless Inter-Domain Routing (CIDR) scheme is to apply a successive series of masks to an address starting with the longest mask, and searching for a match in a database, thereby finding the longest match. The mask extraction hardware and method described below provides procedures and mechanism for expanding an encoded mask vector (e.g., MaskWord) into the appropriate series of masks.

As mentioned earlier, those trying to implement this type of mask expansion in software or in FPGAs cannot efficiently use typical approaches available to ASIC designers. However, processors do have efficient instruction sets and many FPGAs have circuitry “tuned” to implement arithmetic functions. Therefore, if the target platform is software running on a standard processor or an FPGA, the longest mask can be expanded from an encoded mask vector by the following equation, which provides a fast, compact solution:

Mask=((0−MaskWord)|MaskWord

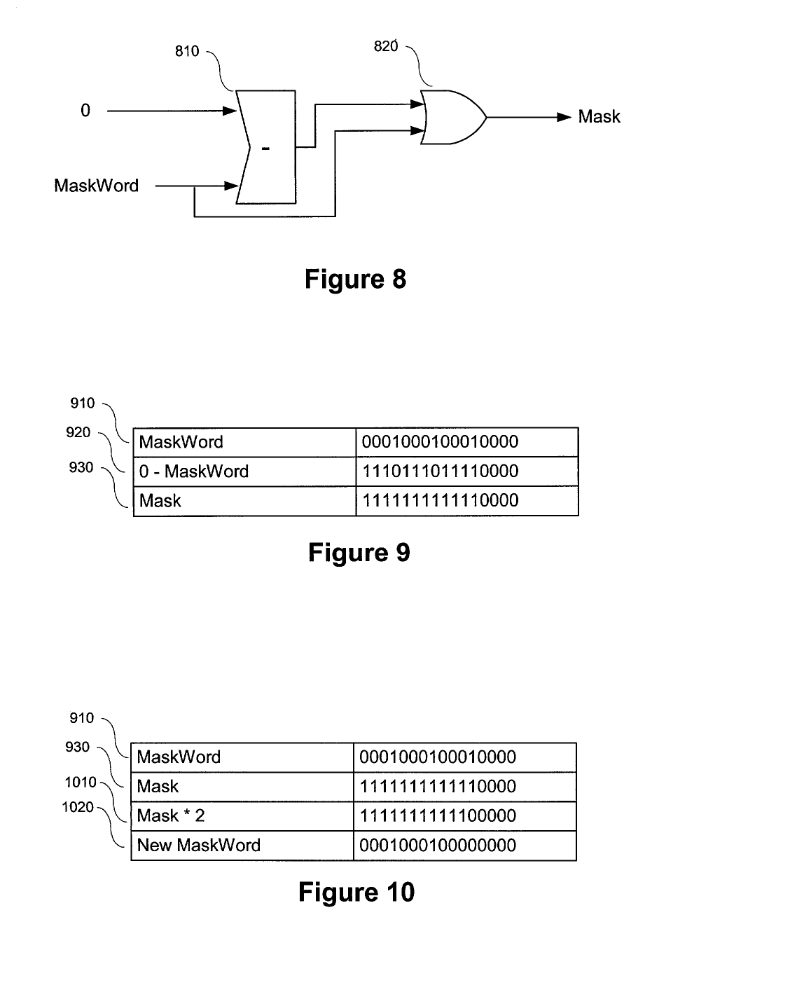

In the above equation, the first part of the equation subtracts the MaskWord from 0 in two's complement arithmetic. If the MaskWord has just a single bit set to one, then its two's complement is the desired mask; i.e., it has a one in the same position as the one in the MaskWord, all of the higher order bits are set to one, and all of the lower order bits are zeroes. If, however, the MaskWord has more than one bit set to a one, then its two's complement is the desired mask except than there is a zero in each position in which MaskWord had a one other than the lowest order one. Thus, by calculating the OR of the two's complement of the MaskWord with the MaskWord itself, the equation fills in the holes left by the higher order bits. FIG. 8 conceptually illustrates a hardware implementation of the mask extraction function according to one embodiment of the present invention employing a standard subtract circuit 810 and an array of OR gates 820.

FIGS. 9 and 10 illustrate the function of the hardware implementation of FIG. 8 and subsequent expansions according to one embodiment of the present invention. Regardless of how the first mask 930 is expanded from the MaskWord 910, the techniques described herein can help to expand subsequent masks by creating a new MaskWord 1020 by forming the AND of the original MaskWord 910 with the current mask after it has been shifted left one position 1010. Thus, the new MaskWord 1020 is the same as the former 910 with the bottom one changed to a zero.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method of performing a longest match search comprising:
receiving a search key;
determining a set of masks that when applied to the search key are known to have a potential for matching an entry in a routing table;
forming a routing table query based upon the search key and a longest mask of the set of masks; and
applying the routing table query to the routing table.

2. The method of claim 1, further comprising:
removing the longest mask from the set of masks; and
continuing to apply additional routing table queries until either the set of masks is empty or a matching entry is found in the routing table.

3. The method of claim 1, wherein the search key comprises an Internet Protocol (IP) address.

4. The method of claim 3, wherein the IP address comprises a destination address.

5. The method of claim 3, wherein the IP address comprises a source address.

6. The method of claim 1, wherein said determining a set of masks comprises retrieving an encoded mask vector from a mask table based upon the search key, the encoded mask vector having N bits and capable of identifying N different length masks.

7. The method of claim 1, wherein the longest mask of the set of masks is determined by the following equation: Mask=(0−MaskWord)|MaskWord, where:
MaskWord is an encoded mask vector, and
Mask is the longest mask identified by MaskWord.

8. A packet forwarding device comprising:
a plurality of ports upon which packets are received and transmitted;
a routing processor coupled to the plurality of ports to determine an egress port of the plurality of ports for a packet received on an ingress port of the plurality of ports by performing a longest match search comprising one or more routing table queries;
a routing table, coupled to the routing processor, to provide the routing processor with a match indication and information regarding a matching routing table entry, if any, of a plurality of routing table entries stored therein in response to a routing table query; and
a mask table, coupled to the routing processor, to maintain encoded mask vectors identifying mask lengths of the plurality of routing table entries.

9. The packet forwarding device of claim 8, the encoded mask vectors comprise N-bits and are capable of representing N different masks.

10. The packet forwarding device of claim 8, wherein the routing table comprises a Content Addressable Memory (CAM).

11. The packet forwarding device of claim 8, wherein the one or more routing table queries are formed by applying a series of masks determined with reference to the mask table to a search key extracted from the received packet.

12. A method of forwarding a packet comprising:
receiving a packet on an ingress port of a plurality of ports;
extracting a destination Internet Protocol (IP) address from a header of the packet;
using a portion of the destination IP address to index into a mask table to retrieve an encoded mask vector that identifies a series of masks to be applied to the destination IP address during a longest match search of a routing table, the series of masks representing those masks that are known to have a potential for matching an entry in the routing table when applied to the destination IP address;
identifying a longest matching entry in the routing table by performing the longest match search based upon the destination IP address and one or more of the series of masks; and
forwarding the packet to a network device associated with the destination IP address via an egress port of the plurality of ports identified by the longest matching entry.

13. The method of claim 12, wherein the portion of the destination IP address comprises the most significant N bits of the destination IP address.

14. The method of claim 12, wherein the encoded mask vector includes a plurality of mask length indicator bits that each indicate a mask length by virtue of their position within the encoded mask vector.

15. The method of claim 12, further comprising updating the mask table to include a new encoded mask vector in response to receiving a new routing table entry.

16. A machine-readable medium having stored thereon data representing sequences of instructions, the sequences of instructions which, when executed by a processor, cause the processor to:
receive a search key;
determine a set of masks that when applied to the search key are known to have a potential for matching an entry in a routing table;
form a routing table query based upon the search key and a longest mask of the set of masks; and
apply the routing table query to the routing table.

17. The machine-readable medium of claim 16, wherein the longest mask of the set of masks is determined by the following equation: Mask=(0−MaskWord)|MaskWord,
where:
MaskWord is an encoded mask vector, and
Mask is the longest mask identified by MaskWord.

18. The machine-readable medium of claim 16, wherein the set of masks is determined by retrieving an encoded mask vector from a mask table based upon the search key, the encoded mask vector having N bits and capable of identifying N different length masks.
